(19) United States
(12) Patent Application Publication
(10) Pub. No.: US 2007/0027807 A1
(43) Pub. Date: Feb. 1, 2007

(54) Protecting against fraud by impersonation

(76) Inventor: Alexandre Bronstein, Palo Alto, CA (US)

Correspondence Address: Paul H. Horstmann, 706 Tenth Street, Hermosa Beach, CA, 90254, US

(21) Appl. No.: 11/193,720

(22) Filed: Jul. 29, 2005

(51) Int. Cl. G06Q 40/00

(52) U.S. Cl. 705/44

(57) ABSTRACT

A fraud protection system that enables individuals to take control over securing the use of their own identities. A fraud protection system according to the present teachings includes a registration service that enables an individual to register a set of personalized transaction significance settings. The personalized transaction significance settings enable the individual to control what transactions and conditions associated with those transactions are significant enough to the individual to trigger a security measure. A fraud protection system according to the present teachings further includes an authorization service that receives an authorization request pertaining a transaction purportedly initiated by the individual and that performs a security measure if the transaction significance settings indicate that the transaction is significant to the individual.

### BACKGROUND

A wide variety of institutions and individuals may be vulnerable to a fraud by impersonation. A fraud by impersonation may be defined as an event in which an unscrupulous individual misrepresents their identity. Examples of institutions that may be vulnerable to a fraud by impersonation include banks, lenders, retailers, landlords, schools, government agencies, service providers, trade organizations, etc. Examples of individuals that may be vulnerable to a fraud by impersonation include anyone who may be harmed economically, physically, or psychologically as a consequence of a fraud perpetrated by an unscrupulous individual.

One example of a fraud by impersonation is when an unscrupulous individual steals deposited funds from a bank by misrepresenting themselves to the bank as an account holder. Another example of a fraud by impersonation is when an unscrupulous individual wrongfully obtains personal information from a retailer by misrepresenting themselves to the retailer as a customer. The wrongfully obtained personal information may then be used in another fraud. Another example of a fraud by impersonation is when an unscrupulous individual wrongfully obtains medical information from a healthcare provider by misrepresenting themselves to the healthcare provider as a patient. Yet another example of a fraud by impersonation is when an unscrupulous individual misrepresents themselves to another individual as a trustworthy individual.

A fraud by impersonation may be perpetrated using a variety of communication channels including telephone channels, on-line channels, and personal appearances. For example, an unscrupulous individual may misrepresent their identity in a telephone call or during a personal appearance. In another example, an unscrupulous individual may use wrongfully obtained personal information of a bank customer, e.g. login name, password, etc., to log onto a bank web site and transfer funds out of an account of the bank customer.

Prior methods for protecting against a fraud by impersonation may employ techniques for verifying the identity of an individual. For example, an individual appearing in person may be asked to present a picture identification. An individual on a telephone call may be asked to provide personal information, e.g. social security number, mother's maiden name, etc., via the telephone call. An individual logging onto a web site may be prompted for a password. An individual may be asked to submit to a biometric measurement, e.g. fingerprint, voice print, etc. An individual may be asked to present a token or a password derived from a token. An individual logging onto a web site may be asked to asked to provide information via an alternate communication channel, e.g. a telephone call, a paper mailing.

Unfortunately, prior methods for protecting against a fraud by impersonation may not be readily adaptable to rapidly changing fraud environments and the diverse and changing priorities of individuals seeking protection from fraud. For example, identity thieves exhibit a seemingly inexhaustible supply of ingenuity in conceiving techniques for defeating the latest forms of security. A technique for protecting against a fraud by impersonation that works today may not work tomorrow. As a consequence, individuals may be subjected to a roller coaster ride of anxiety in conducting transactions. In addition, individuals may be at the mercy of whatever security mechanisms and policies that institutions may or may not provide. Moreover, some individuals may be more tolerant of security measures than others.

### SUMMARY OF THE INVENTION

A fraud protection system is disclosed that enables individuals to take control over securing the use of their own identities. A fraud protection system according to the present teachings includes a registration service that enables an individual to register a set of personalized transaction significance settings. The personalized transaction significance settings enable the individual to control what transactions and conditions associated with those transactions are significant enough to the individual to trigger a security measure. A fraud protection system according to the present teachings further includes an authorization service that receives an authorization request pertaining a transaction purportedly initiated by the individual and that performs a security measure if the transaction significance settings indicate that the transaction is significant to the individual.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 illustrates a fraud protection system according to the present teachings;

FIG. 2 shows an example of a set of transaction significance settings selected by an individual;

FIG. 3 shows a mapping table in one embodiment;

FIG. 4 illustrates a fraud protection system used by a bank web site.

### DETAILED DESCRIPTION

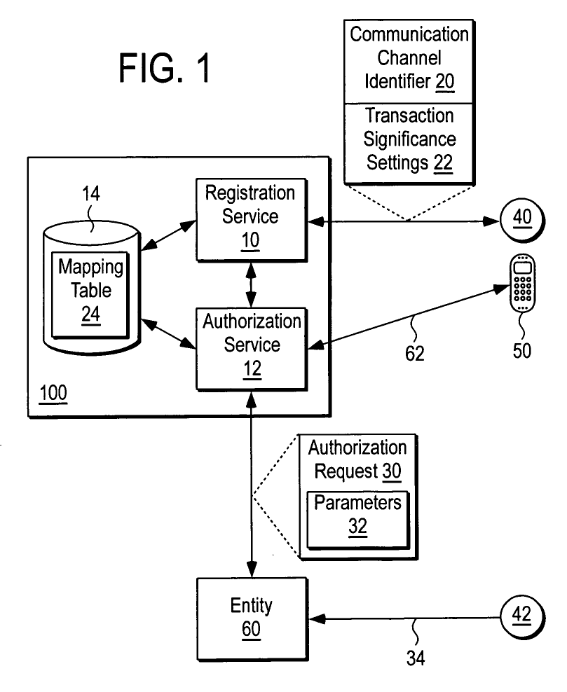

FIG. 1 illustrates a fraud protection system 100 according to the present teachings. The fraud protection system 100 includes a registration service 10 and an authorization service 12 that protect an individual 40 from a fraud perpetrated by an individual 42.

The registration service 10 enables the individual 40 to register a set of transaction significance settings 22. The registration service 10 stores the transaction significance settings 22 in a mapping table 24 in a data store 14. The transaction significance settings 22 provide indications of what transactions the individual 40 deems to be of high enough significance to trigger a security measure.

An entity 60 receives a transaction request 34 from an individual 42. The individual 42 purports to be the individual 40 when making the transaction request 34 to the entity 60. For example, the individual 42 may use personal information pertaining to the individual 40 to represent themselves to the entity 60 as the individual 40. The entity 60 obtains authorization for the transaction request 34 by generating an authorization request 30 to the authorization service 12. The authorization request 30 includes a set of parameters 32 that describe the transaction request 34.

The authorization service 12 in response to the authorization request 30 performs a security measure if the parameters 32 and the transaction significance settings 22 indicate that the transaction request 34 is significant to the individual 40. If the parameters 32 and the transaction significance settings 22 indicate that the transaction request 34 is not significant to the individual 40 then the authorization service 12 does not perform the security measure. In one embodiment, the security measure is a communication via a communication channel 62 identified by a communication channel identifier 20 that the individual 40 registers to the registration system 10 along with the transaction significance settings 22. In the example shown, the communication channel identifier 20 is the phone number of a telephone 50 belonging to the individual 40.

The transaction request 34 may be any communication to the entity 60 in which the individual 42 presents an identity. The transaction request 34 may be provided by the individual 42 to the entity 60 in-person or via a communication mechanism.

The entity 60 may be a bank, a lender, a retailer, a landlord, an educational institution, a government agency, a service provider, a trade organization, etc., or an ordinary individual.

The authorization request 30 may be provided by the entity 60 to the authorization service 12 using any type of communication mechanism, e.g. telephone, email, web interfaces, etc., or may be presented in-person if the authorization service 12 maintains a venue for receiving authorization requests from individuals.

The transaction request 34 may be provided to the entity 60 via any communication channel that the entity 60, e.g. an institution, uses to transact operations with individuals to whom the entity 60 provides services. One example of a communication channel for the transaction request 34 is an on-line connection, e.g. web site, that the entity 60 uses to provide services. Another example, of a communication channel for the transaction request 34 is a telephone connection that the entity 60 uses to provide services. Another example of a communication channel for the transaction request 34 is a venue through which the entity 60 provides services to individuals in-person, e.g. a retail store, a bank teller, an automated bank teller machine, a kiosk, a reception area, etc.

The individual 40 uses the transaction significance settings 22 to express what they deem to be significant transactions. The individual 40 may deem some transactions to be more significant than others. For example, the significance of a request for a transfer of funds from a bank may depend on the dollar amount of the transfer. Similarly, the significance of a request for a purchase from a retailer may depend on the dollar amount of the purchase or a request for a loan may depend on the dollar amount of the loan. In addition, the significance of a request for information pertaining to the individual 40 may depend on the nature of the information requested.

The communication channel 62 may be any communication channel that is not the communication channel through which the transaction request 34 is made. The communication channel 62 may be regarded as an “out of band” communication channel that is not likely to be compromised when a fraudster obtains control of the communication channel through which the transaction request 34 was made. For example, if the transaction request 34 is made through a web site of the entity 60 then the communication channel 62 may be a telephone call or an email communication or a voice over IP (VoIP) channel. In another example, if the transaction request 34 is made in a personal appearance then the communication channel 62 may be a telephone call or an email communication, e.g. to a handheld device.

The communication between the individual 40 and the authorization service 12 via the communication channel 62 provides the individual 40 with an opportunity to explicitly specify whether a fraud by impersonation is underway. An entity, e.g. a bank, may trigger their fraud handling procedures to handle an in-progress fraud in response to the explicit indication from the individual 40.

For example, if the transaction request 34 is a web request to a bank from a fraudster purporting to be the individual 40, a bank customer, e.g. using a stolen login name, password, account number, etc., then a telephone call to the individual 40 may provide an option of notifying the bank that the web request is a fraudulent request. The fraud notification option may be provided verbally by the authorization service 12, e.g. prerecorded messages, voice synthesis, etc., and the response to the option may be made verbally by the individual 40 or entered on the keypad of the telephone 50.

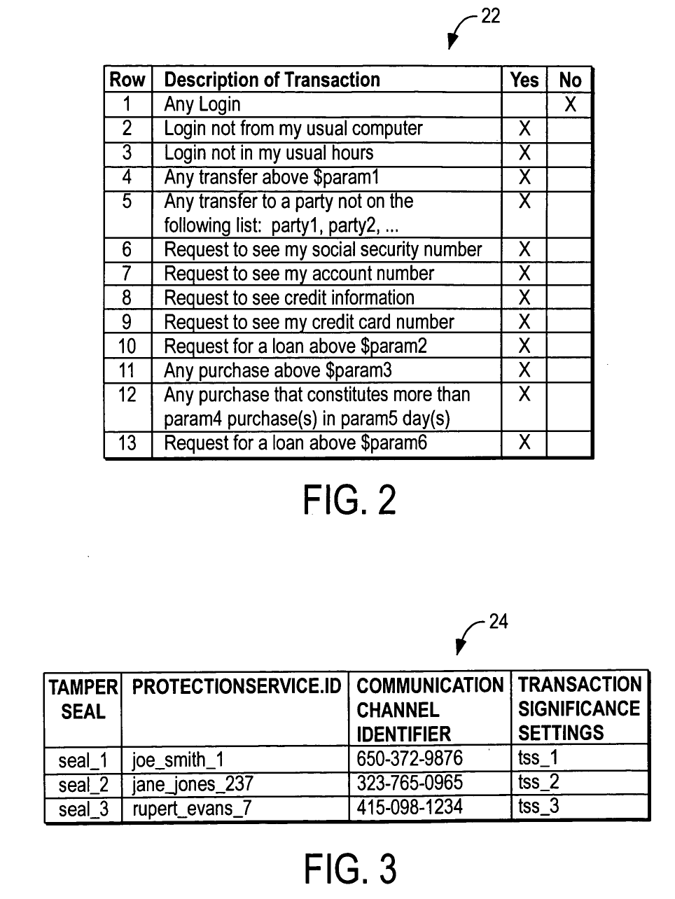

FIG. 2 shows an example of the transaction significance settings 22 selected by the individual 40. The example transaction significance settings 22 are depicted in a table having a set of rows 1-13. Each row includes a corresponding description of a transaction. For example, the row 1 corresponds to any login transaction purportedly by the individual 40, the row 2 corresponds to a login transaction purportedly by the individual 40 from a computer that the individual 40 does not normally use, the row 6 corresponds to a request to see the social security number of the individual 40, etc. A description of a transaction may take any form or have any limitations or any breadth. An example of a broad description of a transaction is “Any communication purportedly from me.”

Each row 1-13 includes a yes/no indicator that the individual 40 sets to indicate whether they deem the corresponding transaction to be significant enough to cause the authorization service 12 to obtain authorization via the communication channel 62. The rows 1-13 may include parameters that may be set by the individual 40. For example, the individual 40 may set the parameter param1 in the row 4 to indicate that any transfer above $param1 is deemed to be significant enough to cause the authorization service 12 to obtain authorization via the communication channel 62. Similarly, the individual 40 may set the parameters party1, party2, . . . in the row 5 to indicate transfers to parties, e.g. bank accounts, payees, etc., that are deemed to be not significant enough to cause the authorization service 12 to obtain authorization via the communication channel 62.

The individual 40 may alter the transaction significance settings 22, e.g. by adding new rows of transactions, changing parameters, switching yes/no settings, etc., depending on their tolerance for taking communications from the authorization service 12 or on their changing concerns over security or on any other consideration. Care should be taken when making changes to the transaction significance settings 22 and/or the communication channel identifier 20. For example, the fraud protection system 100 may require that the individual 40 initially provide the transaction significance settings 22 and/or the communication channel identifier 20 or make changes to the transaction significance settings 22 and/or the communication channel identifier 20 in person or by mail or fax or on-line with a mandatory authorization via the communication channel 62.

In one embodiment, the entity 60 includes a web-connected computer system with security software that generates the authorization request 30 to the authorization service 12 using a call according to a web API of the authorization service 12 that includes the parameters 32 as a set of call parameters. One example of the authorization request 30 using a web API is an https call that specifies a web address of the authorization service 12 and that includes the following call parameters that describe the transaction request 34 (example 1).

PROTECTIONSERVICE.ID=joe_smith_1
TRANSACTION.TYPE=in-person_credit_card_purchase
TRANSACTION.AMOUNT=$2000.00

The authorization service 12 uses the row 11 of the transaction significance settings 22 to determine whether the call parameters for example 1 indicate a transaction that is significant to the individual 40 by determining whether the TRANSACTION.AMOUNT of $2000.00 exceeds the parameter param1 set by the individual 40 if the yes indicator is set in row 11.

Another example set of call parameters in the authorization request 30 is as follows (example 2).

PROTECTIONSERVICE.ID=jane_jones_237
TRANSACTION.TYPE=on-line_credit_card_purchase
TRANSACTION.AMOUNT=$150.00

The authorization service 12 uses the row 11 of the transaction significance settings 22 to determine whether the call parameters for example 2 indicate a transaction that is significant to the individual 40 by determining whether the TRANSACTION.AMOUNT of $150.00 exceeds the parameter param1 set by the individual 40 if the yes indicator is set in row 11. In some embodiments, the transaction significance settings 22 may specify separate threshold parameters for in-person and on-line purchases, i.e. the transaction significance settings 22 may include separate rows for in-person and on-line purchases.

Yet another example set of call parameters in the authorization request 30 is as follows (example 3).

PROTECTIONSERVICE.ID=rupert_evans_7
TRANSACTION.TYPE=web_login
TRANSACTION.DETAIL=login_details

The authorization service 12 uses the rows 1-3 of the transaction significance settings 22 to determine whether the call parameters for example 3 indicate a transaction that is significant to the individual 40 by examining the rows 1-3 in light of the login_details. For example, the login_details may indicate the hour of the login and/or the computer from which the login is requested, to which institution the login is happening, the username being used, etc.

The authorization service 12 passes return values to the call by the entity 60. The return value indicate OK, FRAUD!, or NOT-OK. The return value of OK means that the transaction request 34 is approved. The return value of FRAUD! means that the individual 40 indicated an explicit fraud via the communication channel 62. The return value of NOT-OK means not approved but not indicated as fraud by the individual 40, e.g. the individual may not have answered the communication channel 62, or a technical problem may have prevented communication with the individual 40 via the communication channel 62, or the individual 40 may have changed their mind about a transaction.

The parameters 32 may be given in an XML string or XML document passed as a parameter of a call to the authorization service 12 to provide extensibility of the parameters that describe a transaction. Similarly, the transaction significance settings 22 may be stored in the mapping table 24 in an XML string to provide for extensibility in providing ways for individuals to control their security.

FIG. 3 shows the mapping table 24 in one embodiment. The mapping table 24 includes a set of rows each corresponding to a client, e.g. the individual 40, of the fraud protection system 100. Each row includes a TAMPER SEAL field, a PROTECTIONSERVICE.ID field, a COMMUNICATION CHANNEL.ID field, and a TRANSACTION SIGNIFICANCE SETTINGS field.

The registration service 10 and the authorization service 12 index the mapping table 24 using the PROTECTIONSERVICE.ID fields. The PROTECTIONSERVICE.ID is assigned to a client when the client registers with the fraud protection system 100. The PROTECTIONSERVICE.ID is unique to a client of the fraud protection system 100. The PROTECTIONSERVICE.ID may be generated by the registration service 10 as an alphanumeric string that is guaranteed to be unique, e.g. using a service provided by a server operating system (e.g. GUID). The registration service 10 may allow clients to pick their own PROTECTIONSERVICE.ID so long as it is not already in use. The registration service 10 may create the PROTECTIONSERVICE.ID by combining a name provided by the client with a counter (as shown in the example mapping table 24) or by combining a name provided by the client with the date of birth of the client, or client's birthday, etc.

The fields of the mapping table 24 provide the authorization service 12 with information for determining whether transactions are significant to a client as well as communication channel identifiers for communicating with the client. For example, tss2 are the transaction significance settings for jane_jones_237 and 323-765-0965 is a communication channel identifier for communicating with jane_jones_237.

The TAMPER SEAL field provides a digital signature for a row. For example, seal_2 is a digital signature for the row corresponding to jane_jones_237. The registration service 10 may generate seal_2 by performing a cyclic redundancy check calculation on the remaining fields of the row or by performing a hash of the remaining fields of the row. Alternatively, seal_2 may be an encrypted version of 323-765-0965 or jane_jones_237 with a general secret key.

The authorization service 12 re-computes the digital signature for a row when handling an authorization request from an entity and compares the re-computed digital signature to the contents of the TAMPER SEAL field to detect tampering with the mapping table 24. If the authorization service 12 detects a row that has been tampered with then it returns a NOT-OK return parameter.

Alternatively, tampering with a row may be detected by encrypting all of the fields in a row, except the PROTECTIONSERVICE.ID field, with one secret key. The authorization service 12 then decrypts a row when accessing the information in the row.

The registration service 10 may require that a new client submit a phone bill by mail or fax so that a telephone number used as a communication channel identifier may be checked against the name of the new client with a phone company. Similar precautions may be employed when making changes to information in the mapping table 24.

The COMMUNICATION CHANNEL.ID field may hold any identifier for a communication channel to the individual 40. Examples include telephone numbers, including international numbers, pager numbers, VoIP addresses, email addresses, etc.

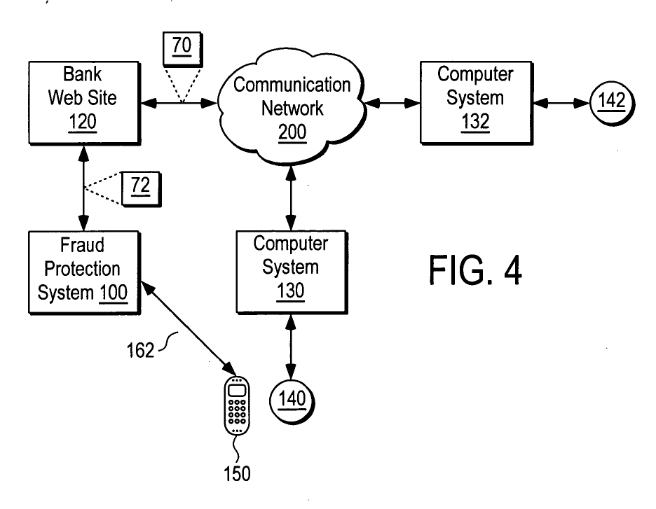

FIG. 4 illustrates the fraud protection system 100 used by a bank web site 120. The bank web site 120 provides on-line banking services to bank customers via a communication network 200 using Internet protocols. The bank web site 120 receives a request 70 that purports to originate from a bank customer 140. The request 70 may be a request contained in an HTML document.

The bank customer 140 accesses their bank account via the bank web site 120 using a computer system 130. For example, the bank web site 120 may generate a login page that enables the bank customer 140 to enter a login name and password using a web browser program running on the computer system 130. In addition, the bank web site 120 may generate web pages that enable the bank customer 140 to make requests that pertain to their account using the web browser on the computer system 130. Examples of requests that may be made by the bank customer 140 via the bank web site 20 include requests to transfer money, requests to pay bills, and requests to display and alter personal information pertaining to the bank customer 140. Examples of personal information pertaining to the bank customer 140 include login name, password, social security number, bank account numbers, security questions, name and address, etc.

A fraudster 142 accesses the bank account of the bank customer 140 via the bank web site 120 using a computer system 132. For example, the fraudster 142 may access the bank account of the bank customer 140 by wrongfully obtaining personal information pertaining to the bank customer 140 and then using the personal information to login to the web site 120 and make the request 70 that purports to come from the bank customer 140. The fraudster 142 may obtain personal information of the bank customer 140 by forging the bank web site 120 and fooling the bank customer 140 into entering their personal information into the forged web site—a technique commonly known as phishing. The fraudster 142 may obtain personal information of the bank customer 140 by intercepting communications between the bank web site 120 and the computer system 130, e.g. by altering domain name translation tables contained on the computer system 130 and/or on domain name servers—a technique commonly known as pharming. The fraudster 142 may obtain personal information of the bank customer 140 by any other means, e.g. by buying the information from a 3^{rd} party, by stealing the information from a 3^{rd} party, by hacking another web site that stores the information, or by older forms of snooping and theft, e.g. going through trash bins.

The fraudster 142 may access the bank account of the bank customer 140 by intercepting communications between the bank web site 120 and the computer system 130 while the bank customer 140 is accessing the bank web site 120. For example, the fraudster 142 may make the request 70 that purports to be from the bank customer 140 without the bank customer 140 being aware that the request 70 was made during a current interaction between the bank customer 140 and the bank web site 120.

The bank web site 120 transfers an authorization request 72 to the fraud protection system 100 in response to the request 70. If the authorization request 72 indicates that the request 70 pertains to a transaction that the bank customer 140 deems significant then the fraud protection system 100 communicates with the bank customer 140 via a telephone call 162 to a cell phone 150 that is possessed by the bank customer 140.

The fraud protection system 100 prompts for a validation input via the telephone call 162. The request 70 will be authorized only if the appropriate validation input is provided via the telephone call 162. For example, the fraud protection system 100 may prompt for a yes/no input, voice or via telephone keypad, to a question such as “Is it OK to grant access to your user account at this time?” The fraud protection system 100 may prompt for an explicit indication of whether the request 70 is a fraud, e.g. using a prompt such as “Press star if the request to transfer funds is a fraud.”

The communication between the fraud protection system 100 and the bank customer 140 via the telephone call 162 may include a security check. For example, the fraud protection system 100 may prompt for a password via the key pad of the cell phone 150. In another example, the fraud protection system 100 may prompt for an answer to a private question or engage in a private dialogue with the bank customer 140 to verify the identity of the party in possession of the cell phone 150.

For example, the mapping table 24 may store a private question associated with the bank customer 140. The fraud protection system 100 may pose the private question to the bank customer 140 via the telephone call 162. In response, the bank customer 140 enters an answer to the private question via the cell phone 150. The fraud protection system 100 may accept that it is the bank customer 140 on the telephone call 162 if the answer entered via the cell phone 150 matches the corresponding answer stored in the mapping table 24. The bank customer 140 may select the private question when registering with the fraud protection system 100. The private question may be associated with a private memory. For example, the private memory of “My trip to Italy last summer” may correspond to a private question of “Who drove you to the airport for that trip last summer?” A private memory/private question combination may lessen the memorization burden on a user in comparison to memorizing a password.

The fraud protection system 100 may be integrated into any existing authorization system used by the entity 60, e.g. an authorization system of a bank that provides the web site 120 or a credit card authorization system provided by a credit card company.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A fraud protection system, comprising:
registration service that enables an individual to register a set of transaction significance settings;
authorization service that receives an authorization request pertaining a transaction purportedly initiated by the individual and that performs a security measure if the transaction significance settings indicate that the transaction is significant to the individual.

2. The fraud protection system of claim 1, wherein the security measure includes communicating with the individual via a communication channel.

3. The fraud protection system of claim 2, wherein the registration service enables the individual to register a communication channel identifier for the communication channel.

4. The fraud protection system of claim 1, wherein the authorization request includes a client identifier associated with the individual.

5. The fraud protection system of claim 4, wherein the client identifier is associated with the individual during registration.

6. The fraud protection system of claim 1, wherein the authorization service receives the authorization request from an entity that received a communication pertaining to the transaction purportedly from the individual.

7. The fraud protection system of claim 6, wherein the entity is an institution.

8. The fraud protection system of claim 6, wherein the entity is another individual.

9. The fraud protection system of claim 1, wherein the transaction is initiated on-line.

10. The fraud protection system of claim 1, wherein the transaction is initiated in-person.

11. The fraud protection system of claim 1, wherein the transaction is initiated via a telephone call.

12. The fraud protection system of claim 1, wherein the authorization service receives the authorization request via a web request.

13. The fraud protection system of claim 1, wherein the authorization service receives the authorization request via a telephone call.

14. The fraud protection system of claim 1, wherein the security measure enables the individual to explicitly indicate a fraud in progress.
